(19) United States
(12) Patent Application Publication
(10) Pub. No.: US 2023/0033454 A1
(43) Pub. Date: Feb. 2, 2023

(54) UE-BASED AND UE-ASSISTED POSITIONING WITH DOWNLINK AND UPLINK MEASUREMENTS FOR UE IN IDLE OR INACTIVE MODE

(71) Applicant: MediaTek Singapore Pte. Ltd., Singapore (SG)

(72) Inventors: Nathan Edward Tenny, San Jose, CA (US); Yuanyuan Zhang, Beijing (CN); Li-Chuan Tseng, Hsin-Chu (TW); Chiao Yao Chuang, Hsin-Chu (TW)

(21) Appl. No.: 17/962,284

(22) Filed: Oct. 7, 2022

Related U.S. Application Data
(63) Continuation of application No. PCT/CN2021/109978, filed on Aug. 2, 2021.

(51) Int. Cl. H04W 64/00; H04W 52/02; H04W 74/08; H04W 74/00

(52) U.S. Cl. CPC H04W 64/006; H04W 52/0229; H04W 74/006; H04W 74/0833

(57) ABSTRACT

Signalling and protocol methods are proposed to allow positioning operations with signals of the cellular system for a UE in idle or inactive mode. In one novel aspect, UL-PRS is embedded in the RACH procedure: a set of RACH preambles with the functionality of UL-PRS are defined. These preambles are sent by the UE to the serving gNB to initiate a RACH procedure, and the following signalling could convey the measurement results. In another novel aspect, positioning operations on the network side are triggered through an AMF. The AMF may elect not to bring the UE to connected mode before transferring the location request to an LMF; instead, the AMF may indicate that the UE is in idle mode and it expects to page the UE with a subsequent message from the LMF.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2021/109978, with an international filing date of Aug. 2, 2021, which in turn claims priority from U.S. Provisional Application Number 63/062,552 filed on Aug. 7, 2020, and U.S. Provisional Application Number 63/075,359 filed on Sep. 8, 2020. This application is a continuation of International Application No. PCT/CN2021/109978, which claims priority from US provisional applications 63/062,552 and 63/075,359. International Application No. PCT/CN2021/109978 is pending as of the filing date of this application, and the United States is a designated state in International Application No. PCT/CN2021/109978. The disclosure of each of the foregoing documents is incorporated herein by reference. the subject matter of which is incorporated herein by reference.

### TECHNICAL FIELD

The disclosed embodiments relate generally to wireless communications system, and, more particularly, to positioning methods for UEs in idle or inactive mode in mobile communication networks.

### BACKGROUND

The existing art in positioning in cellular systems generally assumes that a user equipment (UE) to be positioned is in a connected mode for positioning operations to take place. This means that signalling can be exchanged freely between the UE and the network, allowing, for example, transport of messages of the LTE Positioning Protocol (LPP), which is used in 4G and 5G cellular systems to support positioning operations. However, maintaining a UE in connected mode, e.g., an RRC_CONNECTED state of the radio resource control (RRC) protocol, has costs to power efficiency, and for a UE that is not in connected mode, bringing the UE to connected mode to be positioned takes some time, introducing latency into the positioning process.

Positioning with signals external to the cellular system can often be performed by the UE without network interaction, in a so-called “standalone” mode. This is most often applied to global navigation satellite system (GNSS) positioning methods, where the UE can function as a GNSS receiver and measure signals from the constellation of satellites without any assistance from the network. However, when positioning using the signals of the cellular system is contemplated, the UE generally needs assistance data provided by the cellular system, and in some cases the UE needs a node of the cellular system, for instance, a location management function (LMF), to compute the actual position estimate, in a so-called “UE-assisted” positioning operation.

UE-assisted positioning is particularly challenging for a UE in idle or inactive mode, because it requires that signalling such as assistance data and measurements be carried back and forth between the UE to be positioned, the serving gNode B (gNB), and the LMF, as well as neighbouring gNBs for some cases. However, transport of such signalling through the network requires that the UE be in connected mode, with an associated context in the serving gNB. In the existing art, signalling and procedural support is not present to transport such assistance data and/or configuration between the UE and the network. Further, there is no signalling to report location information (measurements or a position estimate) from an idle or inactive UE back to the network.

There is a need for positioning methods that can be applied to a UE not in connected mode, such as a UE in an RRC_IDLE or an RRC_INACTIVE state of the RRC protocol. A solution is sought.

### SUMMARY

Signalling and protocol methods are proposed to allow positioning operations with signals of the cellular system for a UE in idle or inactive mode. This disclosure describes methods of supporting UE-based and UE-assisted positioning operations when the UE to be positioned is in an idle or inactive mode, using downlink measurements, uplink measurements, or a combination of downlink and uplink measurements. In one novel aspect, uplink positioning reference signals (UL-PRS) are embedded in the RACH procedure: a set of RACH preambles with the functionality of UL-PRS are defined. These preambles are sent by the UE to the serving gNB to initiate a RACH procedure, allowing the gNB to take measurements on the embedded UL-PRS, and the following signalling could convey the measurement results. In another novel aspect, positioning operations on the network side are triggered through an AMF. The AMF may elect not to bring the UE to connected mode before transferring the UE’s location request to an LMF; instead, the AMF may indicate that the UE is in idle mode and it expects to page the UE with a subsequent message from the LMF.

Other embodiments and advantages are described in the detailed description below. This summary does not purport to define the invention. The invention is defined by the claims.

### BRIEF DESCRIPTION OF THE DRAWINGS

FIG. 1 illustrates an exemplary 5G cellular network supporting positioning for a UE in non-connected mode in accordance with one novel aspect.

FIG. 2 shows a simplified block diagram of a UE and a network node in accordance with embodiments of the current invention.

FIG. 3 illustrates an exemplary flow of a UE-based positioning operation using combined UL+DL positioning of a UE in idle or inactive mode.

FIG. 4 illustrates an exemplary flow of a UE-assisted positioning operation using combined UL+DL positioning of a UE in idle or inactive mode.

FIG. 5 illustrates an exemplary flow of a UE-assisted positioning operation using combined UL+DL positioning of a UE in idle or inactive mode, with a two-step RACH procedure.

FIG. 6 illustrates a mobile-terminated location request (MT-LR) procedure with UE-assisted positioning of a UE in idle mode.

FIG. 7 illustrates a mobile-terminated location request (MT-LR) procedure with UE-based DL-only positioning.

FIG. 8 illustrates a mobile-terminated location request (MT-LR) procedure with UE-based positioning using combined DL+UL positioning.

FIG. 9 illustrates RAN paging for an MT-LR procedure with UE-assisted positioning.

FIG. 10 is a flow chart of a self-location positioning method for a UE in non-connected mode in accordance with one novel aspect.

FIG. 11 is a flow chart of a mobile-terminated location request (MT-LR) procedure with UE-based DL-only positioning for a UE in non-connected mode in accordance with one novel aspect.

FIG. 12 is a flow chart of a mobile-terminated location request (MT-LR) procedure using combined DL+UL positioning for a UE in non-connected mode in accordance with one novel aspect.

### DETAILED DESCRIPTION

Reference will now be made in detail to some embodiments of the invention, examples of which are illustrated in the accompanying drawings.

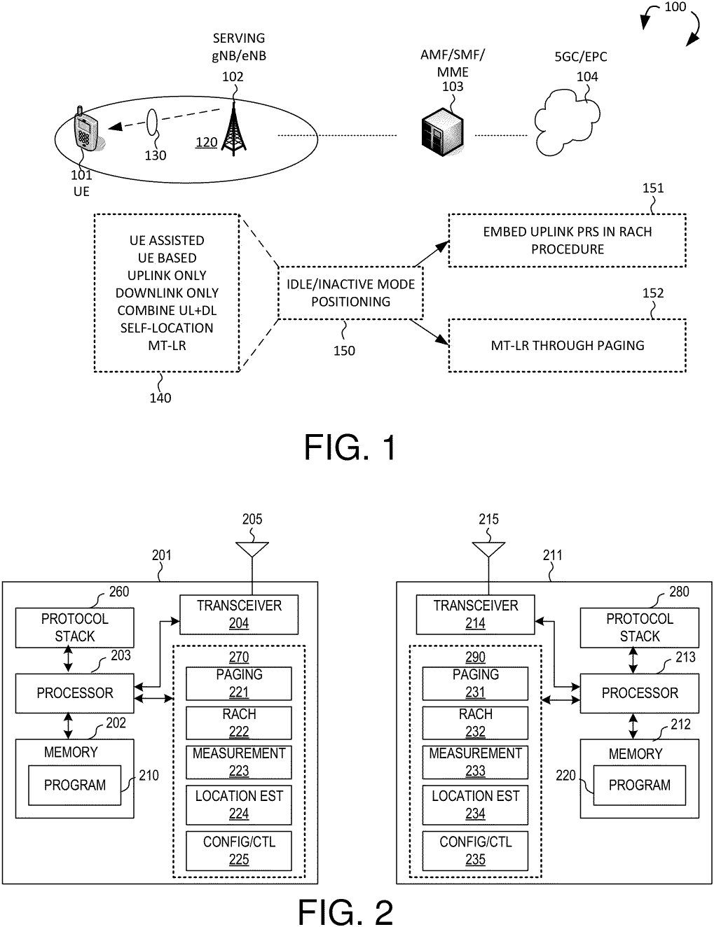

FIG. 1 illustrates an exemplary 5G cellular network supporting positioning for a UE in non-connected mode in accordance with one novel aspect. 5G new radio (NR) network 100 comprises a user equipment UE 101, a serving base station gNB/eNB 102 (and other neighbor gNB/eNB(s), not shown), an Access and Mobility Management Function (AMF)/Session Management Function (SMF)/Mobility Management Entity (MME) 103, and a 5G/4G core network 5GC/EPC 104. In the example of FIG. 1, base station gNB/eNB 102 belongs to part of a radio access network RAN 120. In Access Stratum (AS) layer, RAN 120 provides radio access for UE 101 via a radio access technology (RAT). In Non-Access Stratum (NAS) layer, AMF/SMF 103 communicates with gNB/eNB 102 and 5GC/EPC 104 for access and mobility management and PDU session management of wireless access devices in 5G network 100. UE 101 may be equipped with a radio frequency (RF) transceiver or multiple RF transceivers for different application services via different RATs/CNs. UE 101 may be a smart phone, a wearable device, an Internet of Things (IoT) device, a tablet, etc. The network node may be centralised in the core network (for example, an LMF) or located at the so-called edge of the network (for example, a positioning function collocated with a gNB).

When a UE determines to perform self-location, i.e., to obtain an estimate for its own position, it has several options regarding the choice of positioning method. Within the scope of radio access technology (RAT)-dependent positioning methods, it can use uplink signals transmitted by the UE and measured by network nodes, downlink signals transmitted by network nodes and measured by the UE, or a combination of both. Each set of signals supports various positioning methods: Conventionally, downlink positioning comprises downlink time difference of arrival (DL-TDOA) and downlink angle of departure (DL-AoD) positioning methods, uplink positioning comprises uplink relative time of arrival (UL-RTOA) and uplink angle of arrival (UL-AoA) methods, and combined downlink/uplink positioning comprises a multi-round-trip-time (multi-RTT) method. Multiple methods may be combined to constitute a hybrid positioning method. In addition, timing measurements of downlink and uplink signals can be combined to determine the synchronisation error between base stations.

In the existing art for a UE in an RRC_CONNECTED state, there are signalling methods for the assistance data to be sent from the LMF to the UE, for the uplink signal configuration to be sent from the serving gNB to the UE, for the measurements of downlink signals to be sent from the UE to the LMF, and for the measurements of uplink signals to be sent from the serving and neighbour gNBs to the LMF. Thus it is possible to provide the required downlink and uplink measurements to the LMF to allow for estimating the sync error. In “UE-assisted” positioning, the measurements taken by the UE and/or the gNBs are provided to the LMF and the LMF calculates the final position estimate. In “UE-based” positioning, the UE computes its own position, provided that the uplink measurements are first collected at the serving gNB, and then provided to the UE, where they may be combined with downlink measurements taken by the UE itself.

Various positioning approaches are listed by 140. Critically, the UE in an idle or inactive state cannot exchange signalling with the LMF without first transitioning to a connected state. Moreover, the UE in an idle or inactive state cannot freely exchange signalling with the serving gNB; there are restricted options for communication between an idle or inactive UE and the serving gNB, namely the signalling messages that can be transmitted as part of a random access channel (RACH) procedure. Similar concerns apply to the signalling with the LMF and the serving gNB. However, it is possible under the existing art to deliver assistance data (for instance, information about DL-PRS configurations) to a UE in idle or inactive mode, using the broadcast assistance data facility of the RRC protocol. Assistance data may be packaged as part of a positioning system information block (posSIB) and transmitted by the gNB as part of the system information of the cellular system, thus being available to UEs in any state of the RRC protocol.

To address the limitations, it is necessary to consider modified signalling procedures applicable to the UE in idle or inactive mode (150). In accordance with one novel aspect (151), a set of RACH preambles with the functionality of UL-PRS are defined, meaning that they can be measured reliably by serving and/or neighbour gNBs for timing. Since only the RACH procedure is available to provide signalling between the UE and the serving gNB in idle or inactive mode, it is reasonable to embed the UL-PRS in a message of the RACH procedure, for example, a RACH preamble sent as a first message of a RACH procedure (referred to as Msg1 of a 4-step RACH procedure or MsgA of a 2-step RACH procedure). A RACH preamble from the set of RACH preambles could be sent by the UE to the serving gNB to initiate a RACH procedure, and the following signalling could convey the UL-PRS measurement results taken by the serving and neighbour gNBs.

In another novel aspect (152), for a UE in idle mode, paging comprising a positioning message originates from an access and mobility management function (AMF) in the core network. The LMF may need to interact with the AMF to deliver an initial positioning message (such as a Request Location Information message of the LTE Positioning Protocol (LPP)) to the UE, and the AMF may be able to include the initial positioning message with the paging message. Positioning operations on the network side are normally triggered through the AMF, which selects an LMF and transfers a request for a location operation to it. If the UE is in idle mode, the AMF may elect not to bring the UE to connected mode before transferring the location request to the LMF; instead, the AMF may indicate that the UE is in idle mode and the AMF expects to page the UE with a subsequent message from the LMF.

FIG. 2 illustrates simplified block diagrams of wireless devices, e.g., a UE 201 and a network entity 211 in accordance with embodiments of the current invention. Network entity 211 may be a base station and/or an AMF/SMF. Network entity 211 has an antenna 215, which transmits and receives radio signals. A radio frequency RF transceiver module 214, coupled with the antenna, receives RF signals from antenna 215, converts them to baseband signals and sends them to processor 213. RF transceiver 214 also converts received baseband signals from processor 213, converts them to RF signals, and sends out to antenna 215. Processor 213 processes the received baseband signals and invokes different functional modules to perform features in base station 211. Memory 212 stores program instructions and data 220 to control the operations of base station 211. In the example of FIG. 2, network entity 211 also includes protocol stack 280 and a set of control functional modules and circuitry 290.

Similarly, UE 201 has memory 202, a processor 203, and radio frequency (RF) transceiver module 204. RF transceiver 204 is coupled with antenna 205, receives RF signals from antenna 205, converts them to baseband signals, and sends them to processor 203. RF transceiver 204 also converts received baseband signals from processor 203, converts them to RF signals, and sends out to antenna 205. Processor 203 processes the received baseband signals and invokes different functional modules and circuits to perform features in UE 201. Memory 202 stores data and program instructions 210 to be executed by the processor to control the operations of UE 201. Suitable processors include, by way of example, a special purpose processor, a digital signal processor (DSP), a plurality of microprocessors, one or more micro-processor associated with a DSP core, a controller, a microcontroller, application specific integrated circuits (ASICs), file programmable gate array (FPGA) circuits, and other type of integrated circuits (ICs), and/or state machines. A processor in associated with software may be used to implement and configure features of UE 201.

UE 201 also comprises a set of functional modules and control circuitry to carry out functional tasks of UE 201. Protocol stacks 260 may comprise Non-Access-Stratum (NAS) layer to communicate with an LMF/AMF/SMF/MME entity connecting to the core network, LTE positioning protocol (LPP) layer for positioning, Radio Resource Control (RRC) layer for high layer configuration and control, Packet Data Convergence Protocol/Radio Link Control (PDCP/RLC) layers, Media Access Control (MAC) layer, and Physical (PHY) layer. System modules and circuitry 270 may be implemented and configured by software, firmware, hardware, and/or combination thereof. The function modules and circuits, when executed by the processors via program instructions contained in the memory, interwork with each other to allow UE 201 to perform embodiments and functional tasks and features in the network. In one example, UE 201 receives control and configuration information for positioning via configuration/control module 225, UE 201 in idle or inactive mode performs positioning via paging circuit 221, RACH handling circuit 222, measurement module 223, and location estimate module 224.

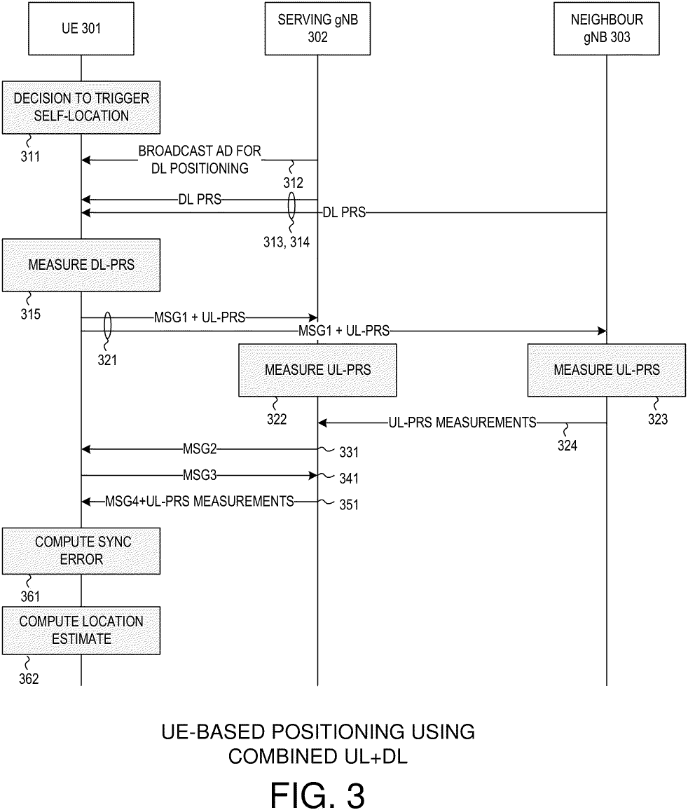

FIG. 3 illustrates an exemplary flow of a UE-based positioning operation using combined UL+DL positioning of a UE 301 in idle or inactive mode. In step 311 of the figure, UE 301 takes the decision to compute its position, i.e. to perform self-location. This decision may be triggered by various events, such as a request from an application layer, for example. In step 312, UE 301 receives broadcast assistance data (AD) for downlink positioning, such as one or more suitable posSIBs, from the serving gNB 302. Based on the contents of the broadcast assistance data, the UE can then monitor the transmission of DL-PRS by the serving and neighbour gNBs, respectively, in steps 313 and 314. In step 315, UE 301 measures the received DL-PRS, for instance to determine the reference signal time difference (RSTD) of the received signals.

In step 321, UE 301 transmits Msg1 of a RACH procedure (or MsgA of a 2-step RACH procedure) towards serving gNB 302, with the signal comprising UL-PRS. The UL-PRS may be embedded in the RACH preamble, for instance, as described above. Step 321 is illustrated twice, once terminating at serving gNB 302 and once terminating at neighbour gNB 303, since both gNBs can receive and measure the same signal. To enable receiving the same signal, the neighbour gNB must monitor the positioning RACH resources that are configured by the serving gNB. One way to achieve this would be to configure consistent positioning RACH resources across a tracking area of the cellular network. This approach is further discussed below. In steps 322 and 323, the serving gNB and the neighbour gNB, respectively, measure the received UL-PRS, to determine, for instance, the time of arrival (TOA) of the UL-PRS at each gNB. In step 324, the neighbour gNB sends its UL-PRS measurements to the serving gNB. It is noted that step 324 requires the neighbour gNB to determine (for instance, from the received UL-PRS in step 321) which gNB is the serving gNB for the detected UE; this information may be encoded in a variety of ways, for example by assigning different RACH resources (e.g., time resources, frequency resources, and/or range of preambles) to different gNBs.

In step 331, serving gNB 302 sends Msg2 of the RACH procedure (e.g., a random access response), and in step 341, UE 301 sends Msg3 of the RACH procedure (e.g., an RRC message such as an RRCSetupRequest or RRCResumeRequest); these steps do not apply if the 2-step RACH procedure is used, and they have no direct bearing on the positioning procedure shown. In step 351, serving gNB 302 transmits Msg4 of the RACH procedure (or MsgB of a 2-step RACH procedure), comprising a message (for instance, a message of the RRC protocol such as an RRCSetup, RRCResume, or RRCReject) that may contain the UL-PRS measurements from steps 322 and 323. At this stage UE 301 is aware of both uplink and downlink measurements, and has the necessary information to compute the sync error between the serving and neighbour gNBs (step 361) and compute its estimated position (step 362).

For the case of UE-assisted positioning, the flow of FIG. 3 presents some difficulties. The principle of UE-assisted positioning is that measurements from the UE are delivered to a network node (for example, an LMF, a gNB, or a positioning server function that may be located in various physical network nodes), and the network node computes a location estimate for the UE. It is thus not possible to avoid including a network node in the positioning flow. The positioning operation may originate from the UE itself (e.g., due to an application layer request for a location estimate) or from a node in the network, such as a location server (e.g., due to a request from an external client); in either case, some coordination is necessary between the UE and the network node, so that the measurements to be delivered by the UE can be correctly processed and associated with the resulting location estimate.

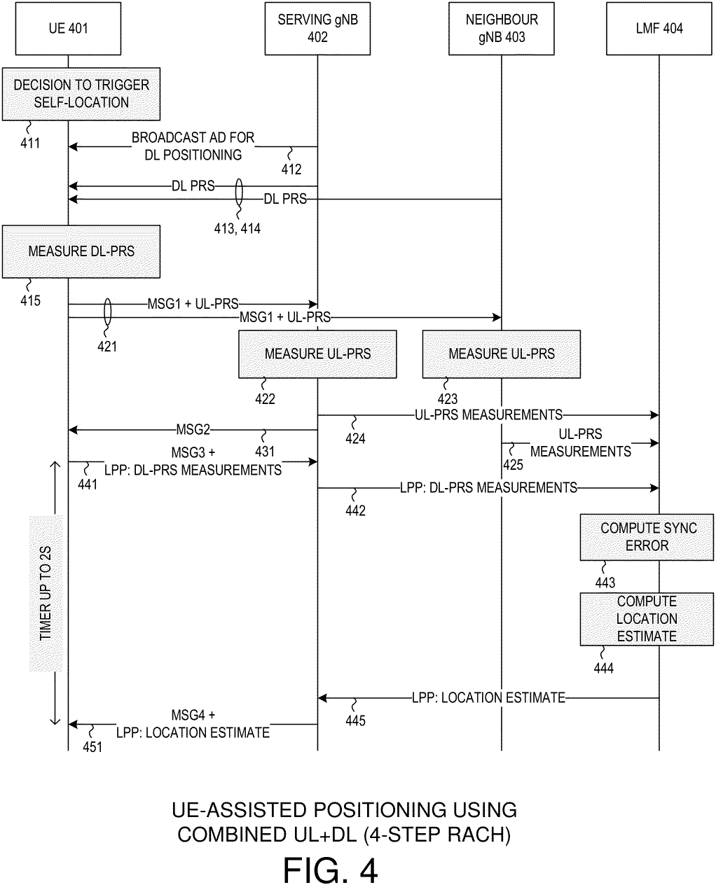

FIG. 4 illustrates an exemplary flow of a UE-assisted positioning operation using combined UL+DL positioning of a UE in idle or inactive mode and using a 4-step RACH procedure. It shows an exemplary general procedure in which a UE triggers a positioning operation using UE-assisted positioning, the position computation being performed by an LMF in the core network and with a 4-step RACH procedure. In step 411 of FIG. 4, UE 401 takes the decision to trigger self-location, i.e. to obtain a location estimate for itself. In step 412, UE 401 receives assistance data (AD) for downlink positioning, e.g., from system information transmitted by gNB 402. (Although step 412 is described in the figure as “broadcast” for brevity, it should be understood that system information is not always transmitted by broadcast over the air; the gNB may elect to transmit one or more blocks of system information on demand through unicast signalling to UEs that request them, and in this case step 412 of the figure may be replaced with a request from the UE and a response from the gNB.) In steps 413 and 414, UE 401 receives DL-PRS signals from the serving and neighbour gNBs, respectively. It should be appreciated that there may be more than one neighbour gNB involved in a positioning operation, and so the UE may receive DL-PRS from more gNBs than shown in the figure, but only one neighbour gNB is shown for simplicity. In step 415, UE 401 takes measurements of the received DL-PRS (for instance, RSTD measurements that reflect the relative time of arrival of the different DL-PRS signals at the UE).

In step 421, UE 401 transmits Msg1 of a RACH procedure, with the signal comprising UL-PRS, similar to step 321 of FIG. 3. Step 421 is illustrated twice, once terminating at serving gNB 402 and once terminating at neighbour gNB 403, since UE 401 may transmit a single signal that is received by both gNBs. In steps 422 and 423, the serving and neighbour gNBs, respectively, take measurements of the UL-PRS (for instance, UL-RTOA measurements reflecting the relative time of arrival of the UL-PRS signal at the different gNBs). In steps 424 and 425, the serving and neighbour gNBs, respectively, report their UL-PRS measurements to LMF 404, using, for example, a message of the NR Positioning Protocol A (NRPPa) protocol. In step 431, serving gNB 402 sends Msg2 of the RACH procedure to UE 401. In step 441, UE 401 sends Msg3 of the RACH procedure to serving gNB 402, with the signal comprising DL-PRS measurements from step 415. The DL-PRS measurements may be carried, for instance, in a message of the LPP protocol, which may be encapsulated as a protocol data unit (PDU) within the signalling format of Msg3. Msg3 may also include an RRC message indicating a connection control operation that the UE requests (for instance, an RRCSetupRequest message, an RRCResumeRequest message, or an RRCResumeRequest1 message). At this step, UE 401 may also start a timer (for example, T300 or T319 as defined in 3GPP TS 38.331) to supervise the completion of the RACH procedure. In step 442, serving gNB 402 forwards the DL-PRS measurements (for example, an LPP PDU comprising the measurements that were received with Msg3 in step 9) to LMF 404.

In step 443, LMF 404 may analyse the UL-PRS and DL-PRS measurements to compute an estimate of the sync error between the involved gNBs. In step 444, LMF 404 computes a location estimate for UE 401. In step 445, LMF 404 sends the location estimate to serving gNB 402; the location estimate may, for example, be carried in a message of the LPP protocol. In step 451, serving gNB 402 transmits Msg4 of the RACH procedure to UE 401, with the signal comprising the location estimate; the location estimate may, for example, be carried in a message of the LPP protocol, which may be encapsulated as a PDU within the signalling format of Msg4. Msg4 may also include an RRC message, which may, for instance, indicate to the UE whether it should come to RRC_CONNECTED state for further communication with the network. An RRC message included with Msg4 may be responsive to any RRC message included with Msg3 in step 441. At this step, UE 401 may terminate the timer that was started at step 441, since the RACH procedure is completed with the reception of Msg4.

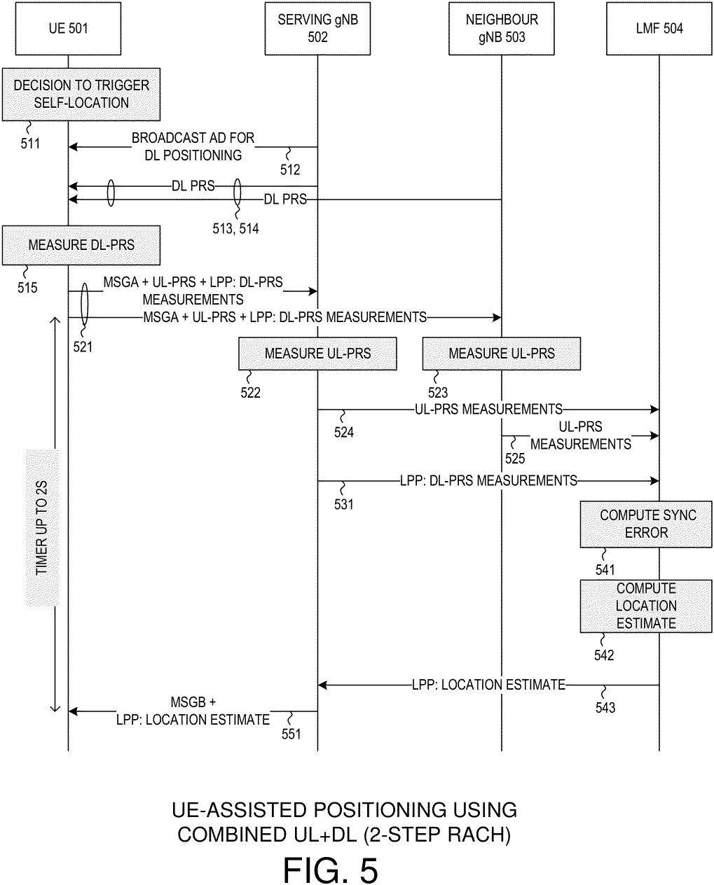

It should be appreciated that variations on the procedure of FIG. 5 are possible. For example, the DL-PRS of steps 413 and 414 may be transmitted by the gNBs in an ongoing manner, and the UE may receive and measure them at a different point in the sequence than illustrated (specifically, at any time before step 441, when the DL-PRS measurements are reported). Similarly, the serving and neighbour gNBs may report their UL-PRS measurements to the LMF before step 431, after step 441, or between steps 431 and 441. In particular, step 424 and step 442 may be combined, so that the serving gNB delivers its own UL-PRS measurements and the UE’s DL-PRS measurements together in a single message. The sync error estimation in step 443 is optional, and a particular LMF implementation may or may not perform this step.

Furthermore, positioning may be performed with only a subset of the steps in FIG. 4. For instance, the system may perform UL-only UE-assisted positioning with the following modifications to the figure. Steps 412 through 415 are omitted; Step 441 does not include DL-PRS measurements; Steps 442 and 443 are omitted. Similarly, the system may perform DL-only UE-assisted positioning with the following modifications to the figure: Step 421 does not include UL-PRS; Steps 422 through 425 are omitted; Step 443 is omitted. Note that the inclusion of DL-PRS measurements with Msg3 (step 441 of FIG. 4) may require extension of the available data space in Msg3 compared to what is available in 3GPP Rel-16. DL-PRS measurements require significant data to describe; for example, a measurement format from LPP comprises a minimum of 16 bits for the RSTD measurement, and 27 bits for a timestamp, for each pair of measured transmit-receive points (TRPs). The maximum size of an RRC message included in Msg3 on common control channel 1 (CCCH1) is 64 bits, meaning that the uplink format may need to be extended. An alternative to extending Msg3 is to use 2-step RACH, where more transport space may be available in MsgA compared to Msg3 of the 4-step RACH.

FIG. 5 illustrates an exemplary flow of a UE-assisted positioning operation using combined UL+DL positioning of a UE in idle or inactive mode, with a two-step RACH procedure. Steps 511-515 of FIG. 5 are identical to steps 411-415 in FIG. 4: UE 501 determines to obtain its position, receives assistance data from system information (e.g. by broadcast or by on-demand transmission; the figure indicates “broadcast” for brevity), and receives and measures DL-PRS from the serving and neighbour gNBs. In step 521, UE 501 transmits MsgA of the 2-step RACH procedure, comprising UL-PRS as well as DL-PRS measurements from step 515. The DL-PRS measurements may be included in a message of the LPP protocol, which may be encapsulated in a message (for example, an RRC message) carried by MsgA. At substantially the same time, UE 501 may start a timer such as T300 or T319, acting as a supervisory timer on the 2-step RACH procedure. MsgA may also include an RRC message indicating a connection control operation that the UE requests (for instance, an RRCSetupRequest message, an RRCResumeRequest message, or an RRCResumeRequest1 message). In steps 522 and 523, the serving and neighbour gNBs, respectively, measure the UL-PRS included with MsgA. In steps 524 and 525, the serving and neighbour gNBs, respectively, send their UL-PRS measurements to LMF 504. In step 531, serving gNB 502 delivers the UE’s DL-PRS measurements (as received in step 521) to LMF 504. It should be appreciated that steps 524 and 531 may be combined; that is, the UL-PRS measurements and the DL-PRS measurements may be carried in a single message. In step 541, LMF 504 computes an estimate of the sync error between the measured gNBs. In step 542, LMF 504 computes a location estimate for UE 501. In step 543, LMF 501 sends the location estimate to serving gNB 502, using, for instance, a transport message that may encapsulate a message of the LPP protocol. In step 551, serving gNB 502 transmits MsgB of the 2-step RACH procedure to UE 501, including the location estimate that it received in step 543. MsgB may also include a connection control message, such as an RRC message, which may be responsive to any RRC message included in MsgA at step 521.

In both FIG. 4 and FIG. 5, it is possible to aggregate UL-PRS measurements at the serving gNB instead of sending them independently from the serving gNB and the neighbour gNB to the LMF. To achieve this, in FIGS. ⅘, step 425/525 is omitted, and an intermediate step is added after steps 422/522 and 423/523 but before step 424/524, in which the neighbour gNB delivers its UL-PRS measurements to the serving gNB. Subsequently, when the serving gNB sends its own UL-PRS measurements to the LMF, it can also include UL-PRS measurements from one or more neighbour gNBs. The serving and neighbour gNBs may determine which involved gNB is the serving gNB based on characteristics of the received signal (for instance, the choice of time, frequency, and/or preamble resources used for the initial RACH transmission-Msg1 or MsgA) .

In addition to the case where the UE itself originates the positioning operation, it is also possible for positioning to be triggered from the network side, e.g., by a request from a Location Services (LCS) client. An example is a Mobile-Terminated Location Request (MT-LR) procedure. In this case, a positioning server function in a network node, such as an LMF, needs to send a message to the UE to instigate positioning operations. In principle, this triggering message (for instance, a Request Location Information message of the LPP protocol) could be delivered to the UE in a paging message; however, there is a complication in that neither the LMF nor the gNBs can know in advance which gNB serves the UE. This is a characteristic of UEs in idle or inactive mode.

When a UE is in idle mode, paging originates from the access and mobility management function (AMF) in the core network. The LMF may need to interact with the AMF to deliver an initial positioning message (such as a Request Location Information message of the LPP protocol) to the UE, and the AMF may be able to include the positioning message with the paging message. Positioning operations on the network side are normally triggered through the AMF (for instance, a location entity in the core network may send a location service request to the AMF), which selects an LMF and transfers the request for a location operation to it. If the UE is in idle mode, the AMF may elect not to bring it to connected mode before transferring the location request to the LMF; instead, the AMF may indicate that the UE is in idle mode and it expects to page the UE with a subsequent message from the LMF.

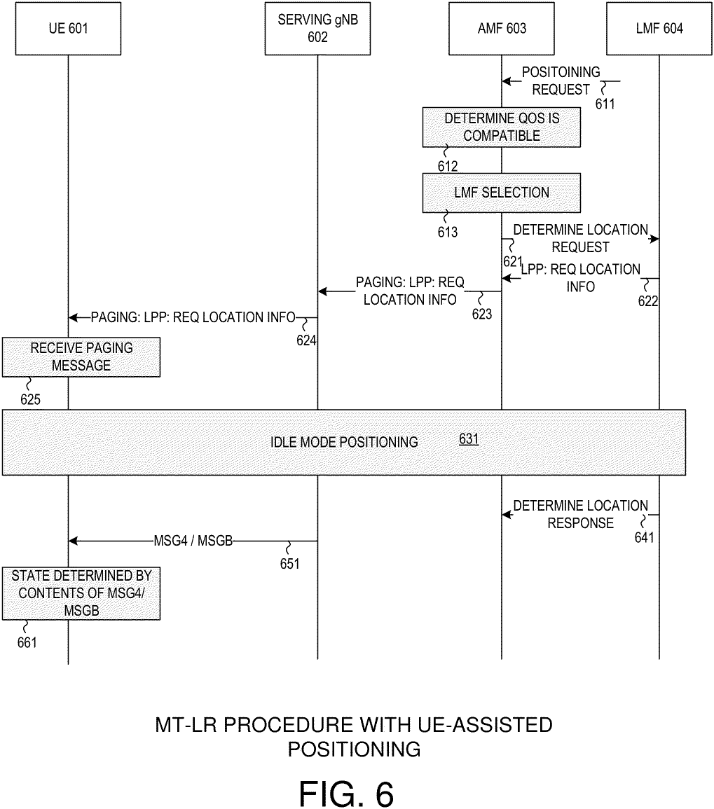

FIG. 6 illustrates a mobile terminated location request (MT-LR) procedure with UE-assisted positioning of a UE in idle mode. In step 611 of FIG. 6, a request comes from an entity in the core network to AMF 603 for location of UE 601; this message may come from a Gateway Mobile Location Center (GMLC) that is handling a request from an LCS client. The message of step 611 may comprise an invocation of an Namf_Location_ProvidePositioningInfo Request service offered by AMF 603. In step 612, AMF 603 determines that the request is suitable for positioning in idle mode, for example, by evaluating the requested quality of service (QoS) and determining that the QoS is expected to be satisfied by an idle mode positioning operation. In step 613, AMF 603 performs LMF selection to determine which LMF in the network should serve the request. In step 621, AMF 603 sends a determine location request to selected LMF 604; this message may comprise an invocation of an Nlmf_Location_DetermineLocation Request service offered by LMF 604. In step 622, LMF 604 sends a first message destined for UE 601, such as a Request Location Information message of the LPP protocol, to AMF 603. The first message may be encapsulated as an LPP PDU in a message from LMF 604 to the AMF 603.

In step 623, AMF 603 originates a paging message for UE 601 and delivers it to serving gNB 602, along with the first message (which may be encapsulated as an LPP PDU in the paging message, for example). The paging message may also be sent to other gNBs (recalling that the AMF does not have prior knowledge of which gNB serves the UE in idle mode). The exact selection of gNBs to receive the paging message is part of the AMF implementation, but a typical approach might send the paging message to all gNBs in the tracking area where the UE last registered. In step 624, serving gNB 602 sends the paging message over the air for UE 601, with the transmission also comprising the first message. Note that at this stage, serving gNB 602 is not aware that it is the serving gNB; it is simply forwarding a paging message that AMF 603 requested it to deliver. In step 625, UE 601 receives the paging message, and determines from the inclusion of the first message that a positioning operation is needed.

Step 631 of FIG. 6 comprises the idle mode positioning operations already described in FIG. 4 or FIG. 5. In step 641, LMF 604, which has computed the UE’s location estimate, sends a determine location response to AMF 603; this message may comprise a response to an Nlmf_Location_DetermineLocation Request service that was previously invoked by AMF 603. AMF 603 has now obtained the UE’s location estimate and can, for instance, deliver the location estimate to the entity that requested it in step 611. In step 651, serving gNB 602 completes the RACH procedure that started during step 631, by sending Msg4 or MsgB to UE 601. In step 661, UE 601 enters a state that is determined by the contents of the message in step 651. For example, the message of step 651 may comprise an RRCReject message indicating that UE 601 is not being brought to connected mode, and UE 601 will revert to operation in idle mode. Alternatively, the message of step 651 may comprise an RRCSetup message indicating that UE 601 is being brought to connected mode, and UE 601 will enter connected mode (for example, an RRC_CONNECTED state of the RRC protocol) accordingly.

Note that for the case of an MT-LR operation in idle mode with UE-based positioning, the procedure is similar to FIG. 6, but the UE determines its own position, meaning that there must be a method to deliver the computed position to the network (where it can ultimately be forwarded to the entity that requested it, such as an LCS client). When only downlink positioning is involved, the position can be transferred as part of the RACH procedure. It is noted that UE-based uplink positioning would be anomalous as a conventional positioning method, but it may be beneficial to deliver uplink measurements to the UE in a UE-based positioning operation so that it can use them to estimate the sync error between gNBs.

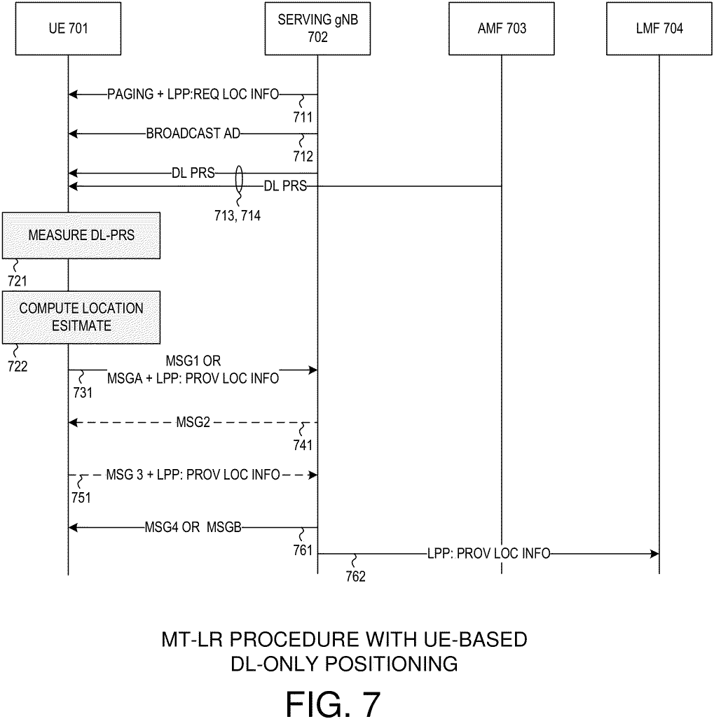

FIG. 7 illustrates a mobile terminated location request (MT-LR) procedure with UE-based DL only positioning. In step 711, UE 701 receives a paging message together with a positioning request, such as a Request Location Information message of the LPP protocol. The network actions leading to this paging message-equivalent to steps 611-623 of FIG. 6-are not shown in FIG. 7 because they are not affected by the differences between UE-assisted and UE-based positioning. It is assumed that the positioning message triggers UE 701 to perform downlink positioning, e.g., by configuring the UE to take measurements of DL-PRS. In step 712, UE 701 receives assistance data for the DL-PRS (as with previous figures, this signalling is described as “broadcast” for brevity, but could also be delivered as on-demand system information). In steps 713 and 714, the serving and neighbour gNBs, respectively, transmit DL-PRS. In step 721, UE 701 measures the received DL-PRS, obtaining, for example, RSTD measurements. In step 722, UE 701 computes its own location estimate based on the measurements from step 721 and the assistance data from step 712, as usual in UE-based positioning.

In step 731, UE 701 begins a RACH procedure by transmitting either Msg1 in case UE 701 is configured to perform 4-step RACH, or MsgA together with a positioning response containing the location estimate (such as a Provide Location Information message of the LPP protocol) in case UE 701 is configured to perform 2-step RACH. In step 741, which applies only in case of 4-step RACH, serving gNB 702 sends Msg2 to UE 701. In step 751, which applies only in case of 4-step RACH, UE 701 sends Msg3 to serving gNB 702, along with a positioning response containing the location estimate (such as a Provide Location Information message of the LPP protocol). In step 761, serving gNB 702 concludes the RACH procedure by sending Msg4 (4-step) or MsgB (2-step) to UE 701. In step 762, serving gNB 702 forwards the positioning response to LMF 704.

If uplink measurements are involved, it is more difficult to perform an MT-LR operation with UE-based positioning for a UE in idle mode. The UE needs to make multiple transmissions to the network: first the UL-PRS to be measured by the gNBs, and subsequently (after the UE has received the gNBs' UL measurements) the location estimate computed by the UE. One approach to this problem is to exploit a facility for small data transmission directly from idle mode. Such a feature would allow the UE to make uplink transmissions of limited size without transitioning to connected mode.

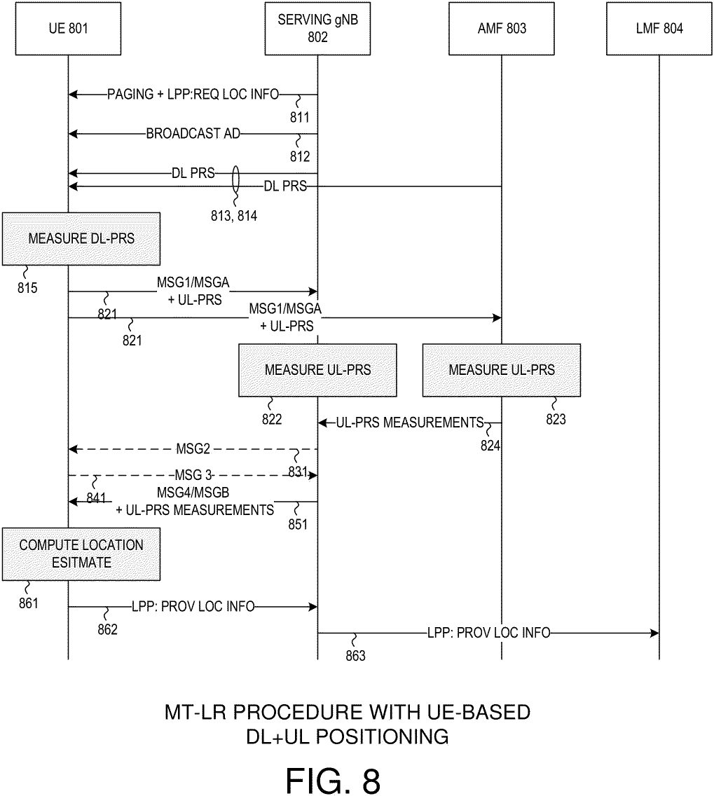

FIG. 8 illustrates a mobile terminated location request (MT-LR) procedure with UE-based positioning using combined DL+UL positioning. FIG. 8 begins with the UE receiving in step 811 a paging message containing a positioning request, such as an LPP Request Location Information message, and the network actions leading to this message are not shown. In step 812, UE 801 receives assistance data from serving gNB 802, either by broadcast (as shown in FIG. 8) or through the on-demand system information mechanism. In steps 813 and 814, the serving and neighbour gNBs, respectively, transmit DL-PRS. In step 815, UE 801 measures the DL-PRS. In step 821, UE 801 starts a RACH procedure by sending either Msg1 (4-step RACH) or MsgA (2-step RACH), along with UL-PRS. In steps 822 and 823, the serving and neighbour gNBs, respectively, measure the UL-PRS. In step 824, neighbour gNB 803 sends its uplink measurements to serving gNB 802, using a suitable protocol defined between the gNBs, such as an XnAP protocol on an Xn interface. In step 831 (applicable only in case of 4-step RACH), serving gNB 802 sends Msg2 to UE 801. In step 841 (applicable only in case of 4-step RACH), UE 801 sends Msg3 to serving gNB 802. It is noted that, as usual in the 4-step RACH procedure, Msg3 may contain a request for a state transition, such as an RRCSetupRequest message. In step 851, serving gNB 802 sends to UE 801 either Msg4 (4-step RACH) or MsgB (2-step RACH), together with the uplink measurements taken by the serving and neighbour gNBs. In step 861, UE 801 computes its location estimate. In step 862, using an uplink transmission mechanism such as a small data transmission facility, UE 801 sends a positioning response, such as an LPP Provide Location Information message, to serving gNB 802. In step 863, serving gNB 802 forwards the positioning response to LMF 804.

With respect to step 824 of FIG. 8, it should be appreciated that direct communication between the gNBs is not the only possible mechanism for delivering UL-PRS measurements from one gNB to another. Instead of performing step 824 as shown, the system may rely on a location server such as an LMF to route measurement results between the gNBs. For instance, after measuring the UL-PRS (step 823), neighbour gNB 803 may deliver its measurement results to LMF 804, and LMF 804 may forward the measurement results to serving gNB 802. As another alternative, one or more of the gNBs may incorporate some functionality of a positioning server, so that, for instance, a “local” positioning server hosted at a neighbour gNB may be responsible for collecting measurements from one or more of the involved gNBs and forwarding the measurements to the serving gNB. Such a procedure may use the Xn interface, but it may encapsulate a positioning protocol (for instance, NRPPa) in messages of the XnAP protocol.

In the above illustrated embodiments, it should be appreciated that the exact order of some steps may vary. For example, a serving gNB may send Msg2 of a RACH procedure while waiting for uplink measurements from a neighbour gNB. Similarly, a UE may transmit the initial message of a RACH procedure before or while measuring DL-PRS signals, rather than waiting for its measurements to complete before transmitting anything. In general, an operation in the illustrated flows may take place whenever the requisite information for the operation is available, without necessarily waiting for all other operations to complete.

Different from the case for idle mode, when a UE is in inactive mode, the core network is not aware of its status, and paging originates from the gNB that holds the UE’s context (typically the gNB to which the UE was most recently connected). The AMF sees such a UE as if it were in connected mode at this “anchor” gNB. Thus the flow of FIG. 6 is not applicable to inactive mode. When an MT-LR occurs, the LMF may still deliver a positioning request (for example, an LPP Request Location Information message) to the AMF, but the AMF will forward the request to the anchor gNB with the expectation that the anchor gNB will deliver it to the UE. The anchor gNB achieves this by a process of “RAN paging”, in which it triggers a paging message across the gNBs in a RAN notification area (RNA) where the UE is camped. To deliver the positioning request to the inactive UE, the anchor gNB can include the positioning request with the RAN paging message, similar to the AMF including the positioning request with the (core network) paging message when the UE is in idle mode.

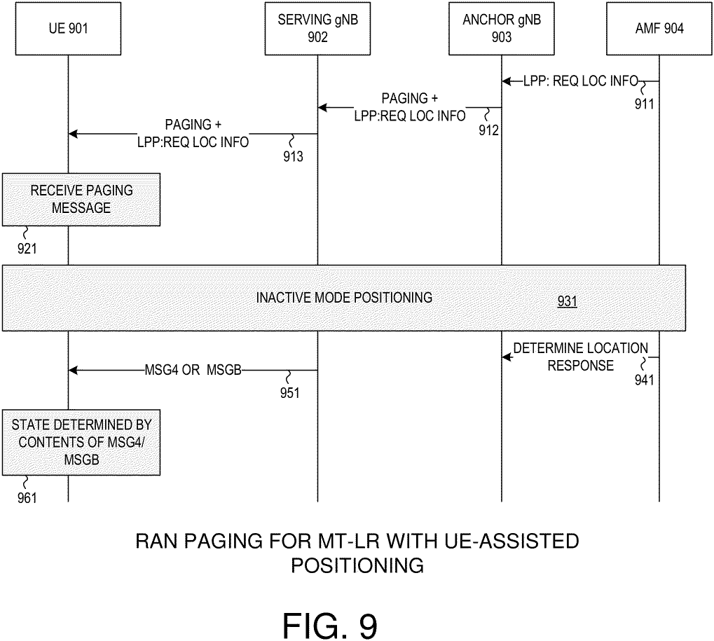

FIG. 9 illustrates RAN paging for an MT-LR procedure with UE-assisted positioning. In step 911 of FIG. 9, AMF 904 forwards a positioning request, such as an LPP Request Location Information message, to anchor gNB 903. The foregoing network interactions are not shown; the AMF is assumed to have selected an LMF in the usual way, and the LMF has sent a first LPP message to instigate positioning operations. In step 912, anchor gNB 903 originates RAN paging towards UE 901, including with the paging message the positioning request. In step 913, serving gNB 902 transmits the page and the accompanying positioning request over the air. In step 921, UE 901 receives the paging message and positioning request. Step 931 comprises the inactive mode positioning procedure for UE-assisted positioning, as shown in steps 412-444 of FIG. 4 or steps 512-542 of FIG. 5. It should be appreciated that from the UE perspective, this procedure is substantially the same as the procedure of FIG. 6: The UE receives a paging message containing a request for location information (for example, an LPP Request Location Information message), receives assistance data, performs DL-PRS measurements, optionally transmits UL-PRS, and delivers its DL-PRS measurements to the LMF, then receives a final message of the RACH procedure (951), which determines the subsequent protocol state of the UE (961).

For the UE-based case in inactive mode, the procedures of FIGS. 7 and 8 can be applied unchanged from the UE perspective. From the LMF’s perspective, the positioning request (for example, the LPP Request Location Information message) was sent to a particular UE, and the positioning response (for example, the LPP Provide Location Information message) was received from the same UE, allowing the messages to be associated. Thus, the methods described herein for positioning in idle mode also facilitate positioning in inactive mode.

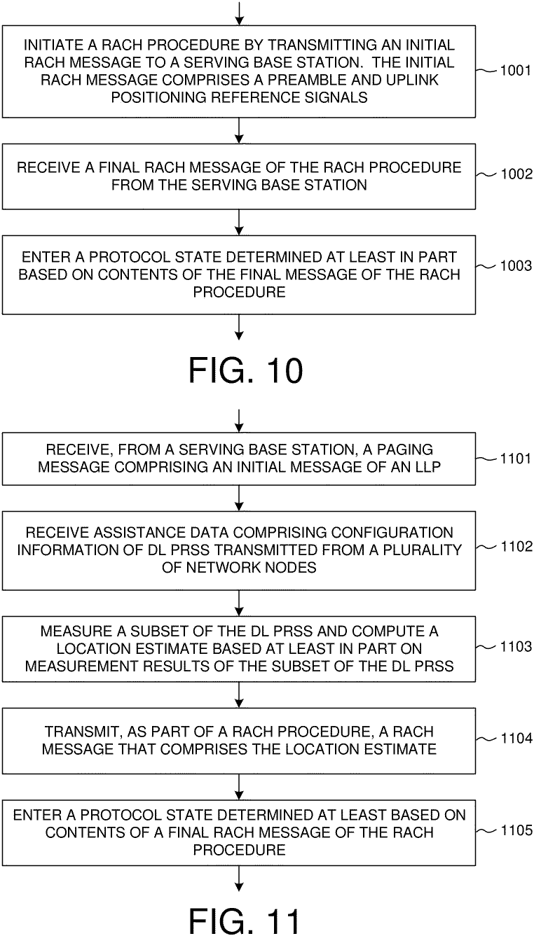

FIG. 10 is a flow chart of a self-location positioning method for UE in non-connected mode in accordance with one novel aspect. In step 1001, a UE initiates a random-access channel (RACH) procedure by transmitting an initial RACH message to a serving base station. The initial RACH message comprises a preamble and uplink positioning reference signals (UL PRSs). In step 1002, the UE receives a final RACH message of the RACH procedure from the serving base station. In step 1003, the UE enters a protocol state determined at least in part based on contents of the final message of the RACH procedure.

FIG. 11 is a flow chart of a mobile terminated location request (MT-LR) procedure with UE-based DL-only positioning for a UE in non-connected mode in accordance with one novel aspect. In step 1101, a UE receives, from a serving network node, a paging message comprising an initial message of an LTE positioning protocol (LPP). In step 1102, the UE receives assistance data comprising configuration information of downlink (DL) positioning reference signals (PRSs) transmitted by a plurality of network nodes. In step 1103, the UE measures a subset of the DL PRSs and computes a location estimate based at least in part on measurement results of the subset of the DL PRSs. In step 1104, the UE transmits, as part of a random access channel (RACH) procedure, a RACH message that comprises the location estimate. In step 1105, the UE enters a protocol state determined at least in part based on contents of a final RACH message of the RACH procedure.

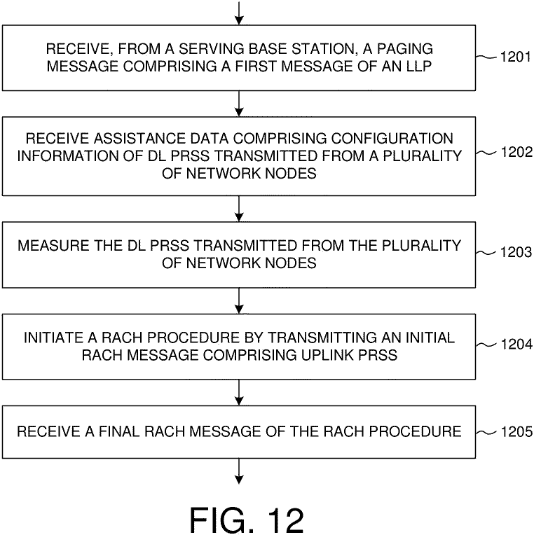

FIG. 12 is a flow chart of a mobile-terminated location request (MT-LR) procedure using combined DL+UL positioning for a UE in a non-connected mode in accordance with one novel aspect. In step 1201, a UE receives, from a serving network node, a paging message comprising a first message of an LTE positioning protocol (LPP). In step 1202, the UE receives assistance data comprising configuration information of downlink (DL) positioning reference signals (PRSs) transmitted by a plurality of network nodes. In step 1203, the UE measures the DL PRSs transmitted by the plurality of network nodes. In step 1204, the UE initiates a RACH procedure by transmitting an initial RACH message comprising uplink (UL) PRSs. In step 1205, the UE receives a final RACH message of the RACH procedure.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A self-location positioning method operable at a user equipment (UE) in a non-connected protocol state, comprising:
initiating a random-access channel (RACH) procedure by transmitting an initial RACH message to a serving base station, wherein the initial RACH message comprises a preamble and uplink positioning reference signals (UL PRSs);
receiving a final RACH message of the RACH procedure from the serving base station; and
entering a protocol state determined at least in part based on contents of the final message of the RACH procedure.

2. The method of claim 1, wherein the RACH procedure is a four-step RACH, wherein the initial RACH message is Msg1 and the final RACH message is Msg4.

3. The method of claim 1, wherein the RACH procedure is a two-step RACH, wherein the initial RACH message is MsgA and the final RACH message is MsgB.

4. The method of claim 1, further comprising:
receiving assistance data comprising configuration information of DL PRSs, the DL PRSs being transmitted by a plurality of network nodes;
measuring a subset of the DL PRSs; and
transmitting a RACH message of the RACH procedure, wherein the message comprises measurement results of the subset of the DL PRSs.

5. The method of claim 4, wherein the RACH message encapsulates a message of an LTE positioning protocol (LPP) .

6. The method of claim 5, wherein the RACH message is Msg3 of a four-step RACH procedure.

7. The method of claim 5, wherein the RACH message is MsgA of a two-step RACH procedure, and wherein MsgA is the initial message that comprises both the UL PRSs and the measurement results of the subset of the DL PRSs.

8. The method of claim 1, wherein the UE receives measurement results of the UL PRSs in the final RACH message of the RACH procedure, wherein the UE computes a location estimate based at least in part on the measurement results of the UL PRSs.

9. The method of claim 1, wherein the UE receives a location estimate in the final RACH message of the RACH procedure.

10. The method of claim 1, wherein the UE is in radio resource control (RRC) idle state or inactive state during the RACH procedure.

11. A mobile-terminated positioning method operable at a user equipment (UE) in a non-connected protocol state, comprising:
receiving, from a serving network node, a paging message comprising an initial message of an LTE positioning protocol (LPP);
receiving assistance data comprising configuration information of downlink (DL) positioning reference signals (PRSs), the DL PRSs being transmitted by a plurality of network nodes;
measuring a subset of the DL PRSs and computing a location estimate based at least in part on measurement results of the subset of the DL PRSs;
transmitting, as part of a random-access channel (RACH) procedure, a RACH message that comprises the location estimate; and
entering a protocol state determined at least in part based on contents of a final RACH message of the RACH procedure.

12. The method of claim 11, wherein the RACH procedure is a four-step RACH procedure, wherein the RACH message is Msg3 comprising the location estimate.

13. The method of claim 11, wherein the RACH procedure is a two-step RACH procedure, wherein the RACH message is MsgA comprising the location estimate.

14. The method of claim 11, wherein the initial message is an LPP Request Location Information message, and wherein the RACH message comprises an LPP Provide Location Information message.

15. A mobile-terminated positioning method operable at a user equipment (UE) in a non-connected protocol state, comprising:
receiving, from a serving network node, a paging message comprising a first message of an LTE positioning protocol (LPP);
receiving assistance data comprising configuration information of downlink (DL) positioning reference signals (PRSs) transmitted by a plurality of network nodes;
measuring the DL PRSs transmitted by the plurality of network nodes;
initiating a RACH procedure by transmitting an initial RACH message comprising uplink (UL) PRSs; and
receiving a final RACH message of the RACH procedure.

16. The method of claim 15, wherein the UE transmits a RACH message comprising measurement results of the DL PRSs to the serving network node.

17. The method of claim 16, wherein the RACH message comprises an LPP Provide Location Information message, and wherein the RACH message is either Msg3 of a four-step RACH procedure or MsgA of a two-step RACH procedure.

18. The method of claim 15, wherein the UE receives the final RACH message comprising measurement results of the UL PRSs.

19. The method of claim 18, further comprising:
computing a location estimate based at least in part on measurement results of the DL PRSs and the measurement results of the UL PRSs; and
transmitting, to the serving network node, a second message of an LPP protocol comprising the location estimate.

20. The method of claim 19, wherein the second message of the LPP protocol is transmitted via a small data transmission facility while the UE remains in the non-connected protocol state.
